(19) United States
(12) Patent Application Publication
(10) Pub. No.: US 2004/0052162 A1
(43) Pub. Date: Mar. 18, 2004

(54) Mechanical chronograph timepiece

(76) Inventor: Takashi Takahashi, Chiba-shi (JP)

Correspondence Address: ADAMS & WILKS, 31st FLOOR, 50 Broadway, New York, NY, 10004, US

(21) Appl. No.: 10/616,389

(22) Filed: Jul. 9, 2003

(30) Foreign Application Priority Data
Jul. 11, 2002 (JP) 2002-202509

(51) Int. Cl. G04F 7/00

(52) U.S. Cl. 368/101

(57) ABSTRACT

To provide a mechanical chronograph timepiece in which an adjustment of a hammer position can be easily performed. A mechanical chronograph timepiece has a hammer support axle setting a basic center axis C, an eccentric portion which is mounted to the hammer support axle, which sets an adjustment center axis Q that is eccentric with respect to the basic center axis C of the support axle and in which a direction of an eccentricity of the adjustment center axis Q with respect to the basic center axis C is adjustable, a hammer possessing a base portion side arm portion supported by an eccentric portion seat so as to be capable of turning about the adjustment center axis Q at a base end portion and two kinds of chronograph hand reset arm portions bifurcated/extended from a tip portion of the base portion side arm portion, and hearts which are respectively capable of returning to their initial positions when pressed by tip portions of the chronograph hand reset arm portions and which are respectively attached to corresponding kinds of chronograph arbors.

### BACKGROUND OF THE INVENTION

The present invention relates to a mechanical chronograph timepiece.

The fact is known that a minute-counting hand and a second-counting hand are returned (reset) to their initial positions by using a hammer having a base portion side arm portion, and a minute-counting hand reset arm portion and a second-counting hand reset arm portion, which are bifurcated at a tip of the base portion side arm portion. As to this kind of hammer, it is constituted such that the minute-counting hand and the second-counting hand are reset by supporting, by means of a turning axle, a base end portion of the base portion side arm portion of the hammer so as to be capable of turning and, by a turn biasing force of a hammer spring, colliding each of tip portions of the respective minute-counting hand reset arm portion and the second-counting hand reset arm portion against corresponding hearts, i.e., minute heart and second heart, thereby returning each of the hearts to its initial position.

In this kind of mechanical chronograph timepiece, the fact itself is also known that, in view of various manufacture tolerances and the like, a size of a gap between the tip portion of the minute-counting hand reset arm portion and the minute heart is made adjustable such that the gap becomes sufficiently small under a state that the tip portion of the second-counting hand reset arm portion butts against the second heart. For the adjustment of this gap, in a conventional mechanical chronograph timepiece, a manner or degree of a deformation of the hammer has been adjusted, i.e., a relative position of the tip portion of the minute-counting hand reset arm portion with respect to the tip portion of the second-counting hand reset arm portion has been changed/adjusted, by forming a circular hole in a root of the bifurcated portion, i.e., tip portion of the base portion side arm portion, of the hammer, forming in a circumferential face of the hole a slit connecting the hole and the bifurcated portion, driving a non-columnar pin whose section is an elliptic shape into the circular hole, and additionally turning the non-columnar pin in the circular hole to thereby change/adjust an opening degree of the slit.

However, since the hammer has a rigidity necessary for mechanically returning each heart to its initial position by the fact that each chronograph hand reset arm portion collides against the corresponding heart under an action of the hammer spring, it consists of a material body whose rigidity is comparatively high, such as an iron-based material, so that not only the driving itself of the non-cylindrical pin is not necessarily easy but also it is not easy to rotate the non-columnar pin in a predetermined direction against the rigidity of the hammer. Further, not only it is necessary to provide an expanding slot leading to a hole of an inner part of the bifurcated portion of the hammer but also it is necessary to separately provide an eccentric pin, so that not only structures of parts are complicated but also it is necessary to ensure a space for driving the pin and a space for allowing a free rotation of the bifurcated portion into which the pin has been driven.

The present invention was made in view of the points mentioned above, and its object is to provide a mechanical chronograph timepiece in which an adjustment of a hammer position can be easily performed.

### SUMMARY OF THE INVENTION

In order to achieve the above object, a mechanical chronograph timepiece of the present invention has a hammer support means setting a basic center axis, an eccentric means which is mounted to the hammer support means, which sets an adjustment center axis that is eccentric with respect to the basic center axis of the support means, and in which a direction of an eccentricity of the adjustment center axis with respect to the basic center axis is adjustable, a hammer possessing a base portion side arm portion supported by an eccentric means so as to be capable of turning about the adjustment center axis at a base end portion and two kinds of chronograph hand reset arm portions bifurcated/extended from a tip portion of the base portion side arm portion, and hearts which are respectively capable of returning to their initial positions when pressed by tip portions of the chronograph hand reset arm portions and which are respectively attached to corresponding kinds of chronograph hands.

In the mechanical chronograph timepiece of the present invention, since there is provided “an eccentric means which is mounted to the hammer support means, which sets an adjustment center axis that is eccentric with respect to the basic center axis of the support means, and in which a direction of an eccentricity of the adjustment center axis with respect to the basic center axis is adjustable”, by adjusting the direction of the eccentricity by operating this adjustable eccentric means, it is possible to adjust initial positions of the two kinds of chronograph hand reset arm portions of the hammer and, by this, initial positions of two kinds of hearts set in compliance with the initial positions of the two kinds of chronograph hand reset arm portions can be adjusted. Accordingly, since it suffices if a position of the hammer is adjusted by attaching the hammer to the hammer support means at an approximate position through the eccentric means and thereafter adjusting the direction of the eccentricity of the eccentric means, no special skill and experience are required for the attachment of the hammer, so that a low cost and rapid assembling becomes possible and also an accurate positioning of the hammer can be easily performed.

The two kinds of chronograph hands are typically any two among “hour-counting hand”, “minute-counting hand” and “second-counting hand”. In case where a precise position of one chronograph hand among the two can be set by a jumper engaging with teeth of a gear wheel integral with the chronograph hand, it suffices if, when the corresponding reset arm portion of the hammer is positioned with respect to the heart becoming integral with the other chronograph hand, a gap between the heart integral with the one chronograph hand and the corresponding reset arm portion of the hammer is adjusted by the eccentric means such that a play owing to the gap becomes less than a unit rotation angle of the gear wheel. The two kinds of chronograph hands are typically the second-counting hand and the minute-counting hand. However, if desired, they may be other combination. In case where reset positions of the second- and minute-counting hands are adjusted, as to the second-counting hand whose deviation in reset position is liable to be especially conspicuous, a state that the corresponding reset arm portion of the hammer and the second heart are butted is made an initial position and the second-counting hand is attached to a second-counting arbor made integral with the second heart while being agreed with a direction of a corresponding dial in the initial position, and a reset position of the minute-counting hand is gap-adjusted by the eccentric means. However, in such a case that a second-counting gear wheel is accompanied by a jumper, if desired it may be adapted such that the reset position of the second heart relating to the second-counting hand is determined by a gap adjustment by the eccentric means.

In the mechanical chronograph timepiece of the present invention, typically, the eccentric means is fitted to the hammer support means so as to be capable of turning about the basic center axis, and the base portion side arm portion of the hammer is fitted to the eccentric means so as to be capable of turning about the adjustment center axis. The hammer support means setting the basic center axis may be an axle or a bearing or hole setting means for receiving the axle, and similarly the eccentric means setting the adjustment center axis may be an axle or a bearing or hole setting means for receiving the axle.

Here, a diameter of the portion, in the eccentric means, fitted to the hammer support means is smaller than a diameter of the portion, in the eccentric means, fitted to the base portion side arm portion of the hammer. However, if desired, it may be the same degree or larger.

In this case, in the mechanical chronograph timepiece of the present invention, for example, even if the hammer support means has a columnar center axle which is supported by the main plate and whose center is the basic center axis and the eccentric means has an eccentric bush fitted to the center axle by its cylindrical inner peripheral face and possessing an outer peripheral face that is eccentric with respect to the inner peripheral face, the hammer support means may include the main plate possessing a cylindrical hole whose center is the basic center axis, and the eccentric means may have a base portion side columnar portion fitted to the cylindrical hole of the main plate and a lever side columnar portion which is formed in one end side of the base portion side columnar portion and which is eccentric with respect to the base portion side columnar portion.

In the mechanical chronograph timepiece of the present invention, typically, an engaged portion extending substantially in a diameter direction with respect to a reference center axis is formed in a surface of the eccentric means such that a direction of an eccentricity by the eccentric means can be adjusted.

In that case, by rotating the engaged portion by engaging an engaging portion such as a tool's tip with it, the direction of the eccentricity can be adjusted easily and accurately. Here, the engaged portion consists of a groove extending in the diameter direction for instance. However, the engaged portion may be formed in a circumferential face of the eccentric means in place of its end face. In that case, the engaged portion consists of a roughened circumferential face region for instance.

In the chronograph timepiece of the present invention, typically, for example, the hammer support means has a columnar center axle which is supported by a main plate and whose center is the basic center axis, and the eccentric means has an eccentric bush which is fitted to the center axle by a cylindrical inner peripheral face and which possesses an outer peripheral face that is eccentric with respect to the inner peripheral face. In that case, the direction of the eccentricity can be adjusted only by rotating the eccentric bush with respect to the center axle. In that case, typically, the eccentric bush has a flange-like portion, and an engaged groove extending substantially in the diameter direction with respect to the reference center axis is formed in a surface of the flange-like portion. In this case, the rotation of the eccentric bush can be easily performed and the adjustment of the direction of the eccentricity is easy, nevertheless such a fear is few that the eccentric bush itself is rotated with respect to the center axle with the rotation of the hammer or the like. However, in order to avoid such a fear that the eccentric bush position-deviates (the direction of the eccentricity changes) with respect to the center axle after the eccentric bush has been positioned with respect to the center axle, preferably there is provided a securing means for fixing the eccentric bush to the center axle. As this securing means, a screw is used for instance. However, it may be whatever other securing means.

In the mechanical chronograph timepiece of the present invention, typically, the chronograph hands include a second-counting hand and a non-second-counting hand, and when a tip portion of, in the hammer, one chronograph hand reset arm portion corresponding to a second heart butts against the second heart and thus is in a state that it returns the second heart to its initial position, a relative position between a tip portion of, in the hammer, the other chronograph hand reset arm portion corresponding to a non-second heart and the non-second heart in its returned position is adjusted in compliance with the direction of the eccentricity of the eccentric means.

Incidentally, such a mechanical chronograph timepiece as mentioned above is typically incorporated into a watch. In this case, the watch typically consists of an analog watch but, if desired, a hand movement controlling portion may be an electronic timepiece.

### BRIEF DESCRIPTION OF THE DRAWINGS

A preferred embodiment of the invention will now be described with reference to the accompanying drawings wherein:

FIG. 1 is a plan explanatory view showing a non-operating state (or reset state), i.e., normal hand movement state, about a chronograph mechanism of a timepiece of one preferred embodiment according to the present invention (XII and III respectively indicate a 12 o'clock direction and a three o'clock direction);

FIG. 2 is an enlarged plan explanatory view about a hammer and related parts for adjusting its eccentric position in the chronograph mechanism of FIG. 1;

FIG. 3 are sectional views (sectional views along approximately IIIA-IIIA line in FIG. 2) shown while being enlarged, wherein FIG. 3A is a sectional explanatory view, and FIG. 3B and FIG. 3C similar sectional explanatory views respectively about modified examples;

FIG. 4 is a graph schematically showing a relation between a turning position of an eccentric bush and a size of a gap between faces of a minute heart and a hammer in the chronograph mechanism of FIG. 2;

FIG. 5 is a front explanatory view of one example of a timepiece possessing the chronograph mechanism of FIG. 1;

FIG. 6 is a plan explanatory view showing a start state, of a chronograph motion, about the chronograph mechanism of FIG. 1; and

FIG. 7 is a plan explanatory view showing a stop state, of the chronograph motion, about the chronograph mechanism of FIG. 1.

### DETAILED DESCRIPTION OF THE PREFERRED EMBODIMENTS

Some of preferred implementation modes of the present invention are explained on the basis of preferred embodiments shown in the attached drawings.

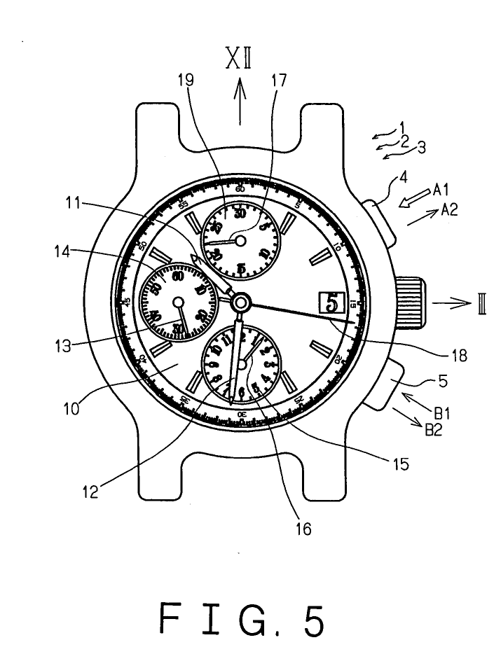

A watch possessing a chronograph timepiece of one preferred embodiment according to the present invention has such an external appearance as shown in FIG. 5 for instance. A watch 1 functions as a usual analog wristwatch 2 giving a usual time indication, and functions as a chronograph timepiece 3 giving an elapsed time indication as a stopwatch, i.e., a chronograph indication. That is, the watch 1 has an hour hand 11, a minute hand 12 and a second hand 13 as well as corresponding dial portions 10 and 14, which give the time indication in the occasion of a usual hand movement, and a chronograph hour hand or hour-counting hand (hereafter referred to as “hour-counting hand”) 16, a chronograph minute hand or minute-counting hand (hereafter referred to as “minute-counting hand”) 17 and a chronograph second hand or second-counting hand (hereafter referred to as “second-counting hand”) 18 as well as relating dial portions 15 and 19, which give a chronograph time indication in the occasion of a chronograph timepiece motion. That is, in this example, the time indication by the hour hand 11 and the minute hand 12 in the occasion of the usual hand movement is performed by the large dial portion 10, and the time indication by the second hand 13 is performed by the small dial portion 14. On the other hand, the time indications by the hour-counting hand 16 and the minute-counting hand 17 in the occasion of a chronograph motion, i.e., stopwatch motion, are performed respectively by the corresponding dial portions 15 and 19, and the time indication by the second-counting hand 18 is performed by the large dial portion 10. Incidentally, in this example, a chronograph minute timer is made a thirty-minute timer. In FIG. 5, “III” and “XII” point to respectively three o'clock and twelve o'clock directions with respect to the dial 10.

The chronograph timepiece 3 has additionally a start/stop button 4 and a reset button 5. As to the chronograph timepiece 3 of the watch 1, in case where it is performing a usual hand movement motion, usually the hour-counting hand 16, the minute-counting hand 17 and the second-counting hand 18 exist respectively in initial positions. In the chronograph timepiece 3, if the start/stop button 4 is pressed in an A1 direction, the hour-counting hand 16, the minute-counting hand 17 and the second-counting hand 18 start a chronograph elapsed time or clocking motion. Incidentally, after being pressed the button 4 is returned to a protruded position in an A2 direction by a spring 55 mentioned later. In the chronograph timepiece 3, if the start/stop button 4 is pressed again in the A1 direction, a chronograph elapsed time or clocking motion is stopped, and the hour-counting hand 16, the minute-counting hand 17 and the second-counting hand 18 are stopped. Next, if the reset button 5 is pressed in a B1 direction, the hour-counting hand 16, the minute-counting hand 17 and the second-counting hand 18 are reset, i.e., returned to zero, and returned respectively to the initial positions, i.e., zero positions. Incidentally, after being pressed the reset button 5 is returned to a protruded position in a B2 direction by a spring 86 mentioned later.

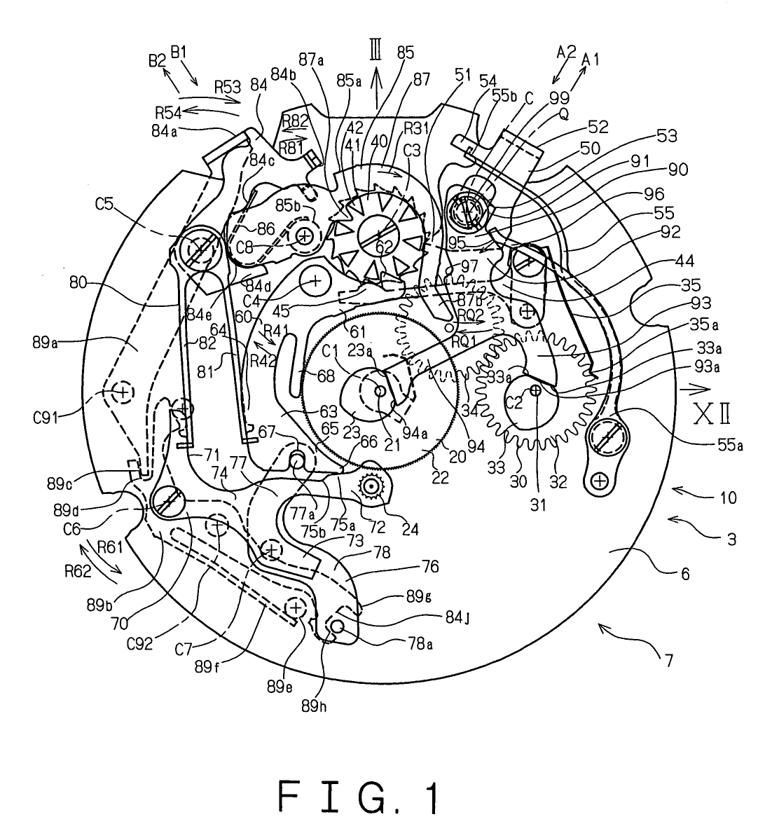

Since a usual analog wristwatch 2 itself for clocking is publicly known, hereunder it is explained on the basis of FIG. 1 to FIG. 4 about the chronograph timepiece 3 of such a watch 1 as mentioned above, moreover among others mainly about portions of the minute-counting hand 17 and the second-counting hand 18, and concerning its chronograph mechanism 7. In FIG. 1, “III” and “XII” respectively point to the three o'clock and twelve o'clock directions with respect to the dial 10 and a relating enclosure or case of FIG.5.

In FIG. 1, a second-counting wheel 20 has a second-counting arbor 21, and a second-counting gear wheel 22 and a second heart 23 which are fixed to the arbor 21, and is rotatable about a center axis C1 of the second-counting arbor 21. The second-counting hand 18 is attached to the second-counting arbor 21.

The second-counting wheel 20 (more detailedly, the second-counting gear wheel 22; the same hereafter) can mesh with a second counter intermediate wheel 24 (more detailedly its gear wheel; the same hereafter). The second counter intermediate wheel 24 always meshes with a second wheel (not shown) of the usual second hand 13 (FIG. 5), of the analog wristwatch 2, indicating a time and, usually, is always rotating with the hand movement.

A minute-counting wheel 30 has a minute-counting arbor 31, and a minute-counting gear wheel 32 and a minute heart 33 which are fixed to the arbor 31, and is rotatable about a center axis C2 of the minute-counting arbor 31. The minute-counting wheel 30 always meshes with a minute counter intermediate wheel 34 (more detailedly, its gearwheel). The minute-counting hand 17 is attached to the minute-counting arbor 31. A minute-counting jumper 35 is elastically pressed at a setting portion 35a to a minute-counting gear wheel 32, thereby setting a rotation of the minute-counting wheel 30.

The chronograph mechanism 7 has a column wheel or pillar wheel 40 for supporting a start (start) and a stop (stop) of a chronograph motion and a returning-to-zero (reset) motion of the chronograph hand. The column wheel 40 is rotatable about its axis C3, posesses even number of ratchet teeth 41 in its circumferential face, and possesses in its end face drive teeth or pillars 42 protruding from the end face in every other one of the ratchet teeth 41. A setting protrusion 45 of a tip of a column wheel jumper 44 fixed at its base end to a main plate 6 is elastically pressed to the ratchet teeth 41. Incidentally, as to this embodiment, it is explained about a type in which the chronograph mechanism 7 has the pillar (column wheel) 40, but the chronograph mechanism 7 may be other type such as a cam system in place of the pillar system.

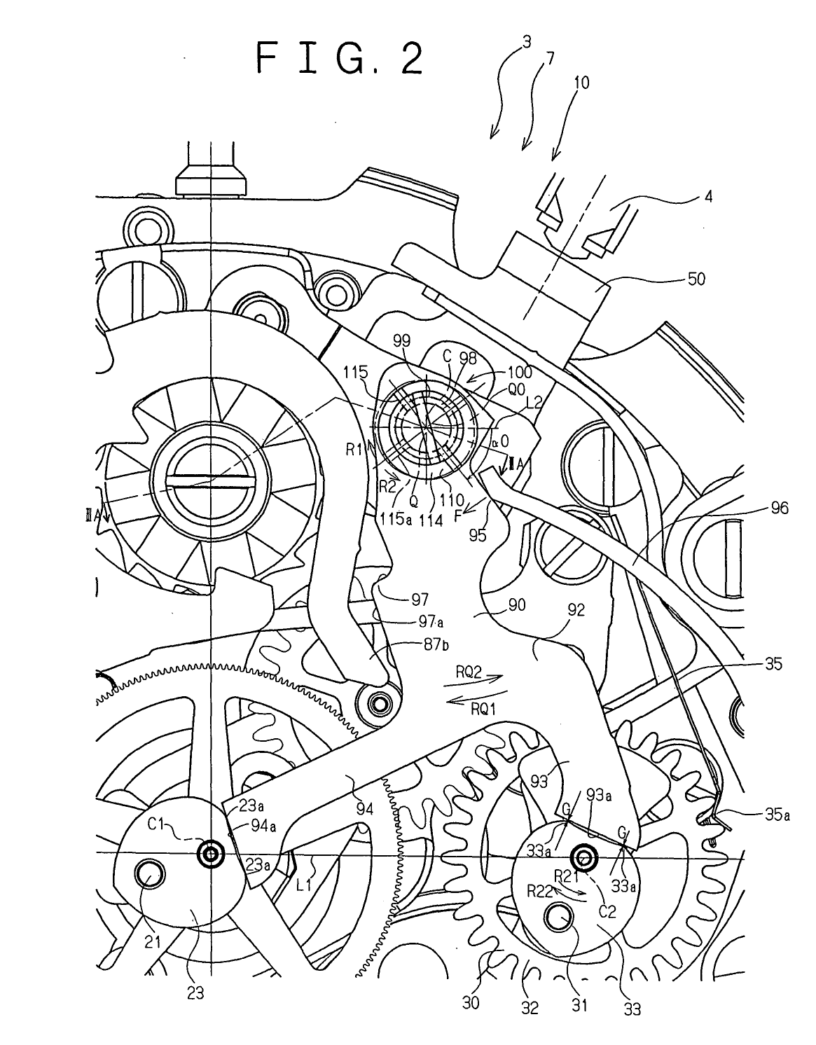

An operating lever 50 integral with the start/stop button 4 (FIG. 2 or FIG. 5) is engageable with the ratchet teeth 41 of the columnar wheel 40 at an operating pawl portion 51. The operating lever 50 has a button operation receiving portion 52 capable of butting against the start/stop button 4, an elongate hole 53 loosely fitted to an operating lever support pin. 99 so as to be relatively movable in the A1 and A2 directions, and a spring receiver 54. A tip 55b of an operating lever spring 55 fixed at its base end 55a to the main plate is locked to the spring receiver 54. Accordingly, the operating lever 50 is movable in the A1 and A2 directions, and always undergoes a biasing force in the A2 direction by the operating lever spring 55. If the operating lever 50 is pressed in the A1 direction, the operating pawl portion 51 of the operating lever 50 engages with the ratchet teeth 41 of the column wheel 40 to press it in the A1 direction, thereby rotating the column wheel 40 by for one pitch in an R31 direction under the setting of the jumper 44. After being pressed in the A1 direction, the operating lever 50 is returned in the A2 direction by the spring 55.

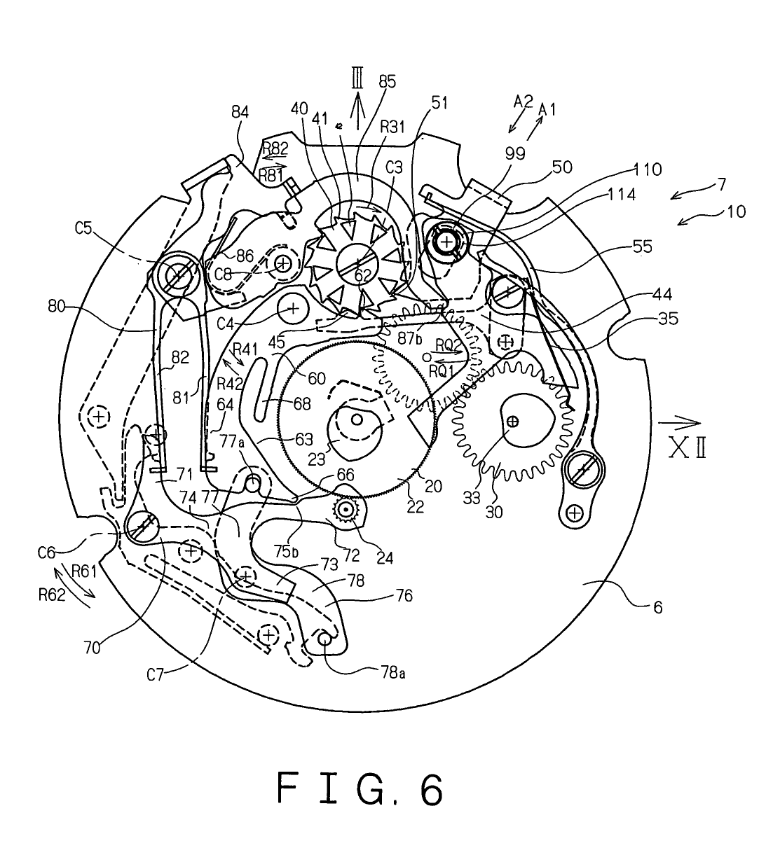

A stop lever 60 capable of turning about a center axis C4 has, in a tip side edge of one arm portion 61, a setting protrusion 62 engageable with the drive teeth or pillars 42 of the column wheel 40 and has, in an outside edge of the other arm portion 63, a chronograph coupling spring butting edge portion 64. Additionally, the arm 63 has, in its tip portion 65, a chronograph coupling lever butting portion 66 and has, in the vicinity of the tip portion 65, a concave portion 67 engaging with an hour chronograph coupling transmission lever operating pin 77a. A setting portion 68 capable of being pressed to a circumferential face of the second-counting gear wheel 22 of the second-counting wheel 20 is branched/extended in an inside edge side of the arm portion 63. Every time the column wheel 40 rotates for one pitch of the ratchet teeth 41, the stop lever 60 adopts alternately a stop position (FIG. 1 or FIG. 2, etc.) where the setting protrusion 62 fits between the adjacent drive teeth 42, 42 and engage with them, and a stop releasing position (FIG. 6, etc.) where it butts against an outer peripheral face of the drive teeth 42. In the stop position, the stop lever 60 turns in an R41 direction, and the setting portion 68 is pressed to the second-counting wheel 20. In the stop releasing position, the stop lever 60 turns in an R42 direction, and the setting portion 68 separates from the second-counting wheel 20, thereby allowing its rotation.

A chronograph coupling lever spring 80 capable of turning about a center axis C5 has bifurcated lever spring portions, i.e., a stop lever spring portion 81 and a chronograph coupling lever spring portion 82, and it is elastically pressed to the butting portion 64 of the stop lever 60 at the stop lever spring portion 81 to thereby apply a rotation biasing force in the R41 direction to the stop lever 60, and is elastically pressed to an arm portion 71 of a chronograph coupling lever 70 at the chronograph coupling lever spring portion 82.

The chronograph coupling lever 70 rotatable in R61 and R62 directions about a center axis C6 has, in addition to the arm portion 71, an arm portion 74 including bifurcated arm portions 72 and 73. The arm portion 72 has an engaged convex portion 75a and a butting release concave portion 75b in a side edge of a tip vicinity, and rotatably supports the second counter intermediate wheel 24 at its tip portion.

A chronograph coupling transmission lever 76 is connected to the arm portion 73 of the chronograph coupling lever 70 so as to be capable of turning about a center axis C7, and the chronograph coupling transmission lever operating pin 77a is attached to an arm portion 77 of the chronograph coupling transmission lever 76 and is engaged with the engaging concave portion 67 of the stop lever 60. An hour chronograph coupling lever operating pin 78a is attached to the other arm 78 of the chronograph coupling transmission lever 76.

A hammer operating lever 84 is capable of turning about the center axis C5 in R53 and R54 directions, capable of butting against the reset button 5 (FIG. 5) in an operation receiving portion 84a, and engages with an engaged concave portion 85a of a hammer click 85 at an engaging protrusion portion 84b. The hammer click 85 is capable of turning about a center axis C8 of a turning axle 85b in R81 and R82 directions, and between the turning axle 85b and an inner edge locking portion 84c of the hammer operating lever 84 there is provided a hammer operating lever spring 86 applying a rotation biasing force in the R54 direction to the hammer operating lever 84. An approximately U-shaped hammer operating lever spring 86 is embraced in its curved bottom portion of U by an inner edge portion 84e of an arm portion 84d of the hammer operating lever 84. The hammer click 85 has an arc-like arm portion 87 of a shape capable of extending approximately along an outer periphery of a train of the drive teeth 42 of the column wheel 40, and the arm portion 87 possesses in its inner peripheral edge a setting protrusion portion 87a engageable between the adjacent drive teeth 42, 42, and possesses in its tip portion a hammer regulating protrusion portion 87b engageable with a hammer 90.

Accordingly, as detailedly mentioned later, when the chronograph mechanism 7 is in its stop state, if the hammer operating lever 84 is turned in the R53 direction against a spring force of the spring 86 by the pressing of the reset button 5 in the B1 direction and presses the engaged concave portion 85a in the R81 direction at the engaging protrusion portion 84b, as mentioned later the hammer regulating protrusion portion 87b of the hammer click 85 separates from the hammer 90 to thereby allow a reset motion by the hammer 90, and the setting protrusion portion 87a of the hammer click 85 fits between the adjacent drive teeth 42, 42 of the column wheel 40. On the other hand, as detailedly mentioned later when the chronograph mechanism 7 is in its reset state, if the column wheel 40 is rotated by for one pitch of the ratchet teeth 41, the setting protrusion portion 87a of the hammer click 85 is turned in the R82 direction by the outer peripheral face of the drive teeth 42, and the hammer regulating protrusion portion 87b returns the hammer 90 to a non-operating position with the turning of the arm portion 87 in the R82 direction.

Incidentally, 89a and 89b are respectively an hour hammer operating lever and an hour chronograph coupling lever concerning the hour-counting hand 16. The hour hammer operating lever 89a capable of turning about a center axis C91 starts a reset operation of the hour-counting hand 16 in compliance with the pressing of the reset button 5 similarly to the hammer operating lever 84 concerning the minute-counting hand 17 and the second-counting hand 18, and is engaged with an operation protrusion portion 89c of the hour hammer operating lever 89a at an engaged concave portion 89d. The hour chronograph coupling lever 89b capable of turning about a center axis C92 is rotation-biased clockwise in FIG. 1, etc. at a spring portion 89f by a pin 89e, and is engageable at an engaging protrusion 89g or 89h with the hour chronograph coupling lever operating pin 78a existing in a concave portion 89j between a pair of engaging protrusions 89g, 89h. This reset mechanism and the like for the hour-counting hand 16 are similar to a mechanism described in JP-A-11-183653 Gazette, so that a detailed explanation is omitted here.

As shown in FIG. 1 to FIG. 3A, the hammer 90 has a base portion side arm portion 92 mounted to an axle structure body 100 at a bearing portion 91 of a base end side so as to be capable of turning, and a minute-counting hand reset arm portion 93 and a second-counting hand reset arm portion 94 which are bifurcated from a tip of the base portion side arm portion 92, and always undergoes a turn-biasing force in an F direction by a hammer spring 96 at a spring receiving portion 95. The minute-counting hand reset arm portion 93 has at its tip a reset face 93a capable of butting against a pair of minimum diameter prescribing portions 33a of the minute heart 33, and the second-counting hand reset arm portion 94 has at its tip a reset face 94a capable of butting against a pair of minimum diameter prescribing portions 23a of the second heart 23. Additionally, the hammer 90 possesses, in an inside edge of the base side arm portion 92, an engaged step portion 97 (shoulder portion 97a capable of releasing the engagement) with which the hammer setting protrusion portion 87b of the hammer click 85 is engageable.

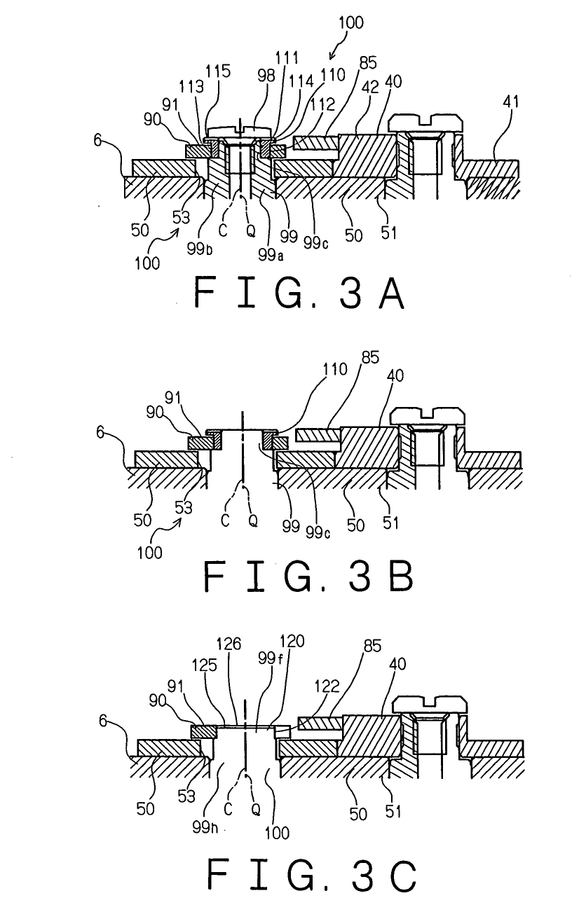

As shown in FIG. 3A, an axle structure body 100 has an eccentric bush 110 fixed by a securing screw 98 in addition to an operating lever support pin 99 as a hammer support means. The operating lever support pin 99 possesses a tip side small diameter axle portion 99c in addition to a base end portion 99a mounted to the main plate and a large diameter axle portion 99b loosely fitted to the elongate hole portion 53 of the operating lever 50, and the eccentric bush 110 is fitted to the small diameter axle portion 99c. The axle portions 99a, 99b may have the same diameter. The eccentric bush 110 has an eccentric cylindrical portion 113 possessing an outer peripheral side cylinder face 112 whose center axis is Q eccentric with respect to an inner peripheral side cylinder face 111 whose center axis is C and a brim or flange-like portion 114 extending outward from a tip of the eccentric cylindrical portion 113 in a diameter direction, and an engaged groove 115 extending approximately in the diameter direction with respect to the center axis C of the inner peripheral side cylinder face 111 is formed in a surface of the flange-like portion 114. Incidentally, the bearing portion 91 of the hammer 90 is fitted to an outer peripheral face of the eccentric cylindrical portion 113 of the eccentric bush 110.

Accordingly, a direction of the eccentricity of the eccentric bush 110 can be adjusted by turning the eccentric bush 110 about the center axis C of the pin 99 by engaging a tip of a small minus driver or the like with the engaged groove 115 of the eccentric bush 110 and, by this adjustment of the direction of the eccentricity, a position of the center axis, i.e., adjustment center axis Q, of the hammer 90 can be adjusted. Incidentally, in this example, a spacing between the basic center axis C and the eccentric or adjustment center axis Q is in the order of 0.05 mm. However, this spacing is one depending on shapes and lengths of the arm portions 93 and 94 of the hammer 90 or the like, and it may be larger or smaller.

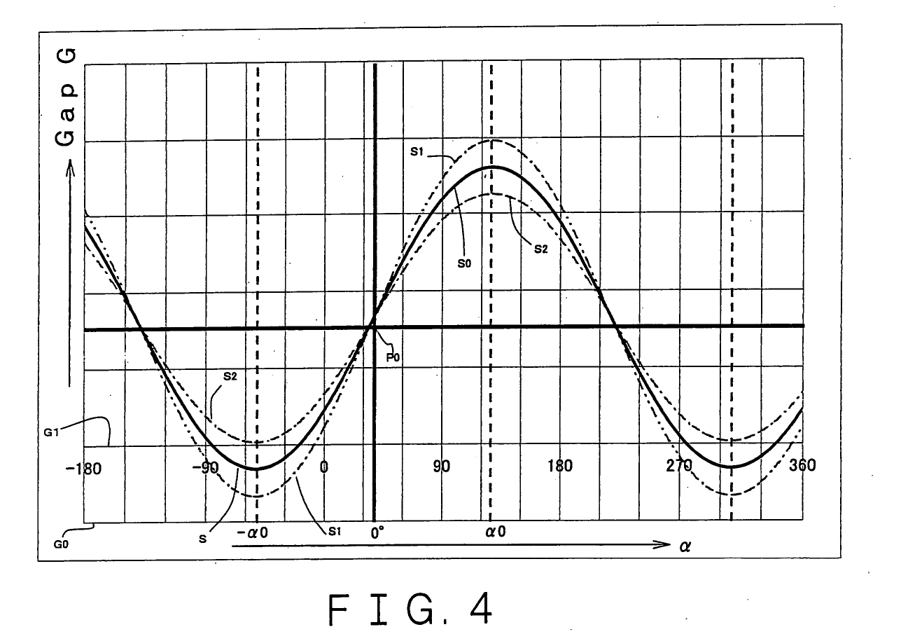

More detailedly, in the example shown in FIG. 2, the groove 115 extends along an eccentric direction, of the eccentric center axis Q, coinciding with the center axis Q of the eccentric bush 110, i.e., the center axis of the outer peripheral face 112 of the eccentric cylindrical portion 113 of the eccentric bush 110. In case where the groove 115 exists in an intermediate position shown by imaginary lines 115a in FIG. 2, if the eccentric bush 110 is rotated about the center axis C in an R1 direction, gaps G between the tip face 93a of the minute-counting hand reset arm portion 93 of the hammer 90 and the minimum diameter prescribing portions 33a, 33a of the minute heart 33 are spread (under a condition that a second heart reset face 94a of the second-counting hand reset arm portion 94 butts against a face prescribed by the corresponding portions 23a, 23a of the second heart 23) and, if it is rotated in an R2 direction, the gaps G become narrow. In FIG. 4, this position corresponds to a position indicated by a point P0. A size of the gap G becomes minimum in case where the eccentric center axis Q deviates by an angle α=+α0 (where, a clockwise direction is made +) with respect to the basic center axis C with an imaginary line L2, which is parallel to an imaginary line L1 connecting the rotation center axis C1 of the second heart 23 and the rotation center axis C2 of the minute heart 33 as shown by a solid line in FIG. 2 and which passes the center axis C, being made a reference (this angle α is +52 degrees in this example).

If the eccentric bush 110 is rotated in the R1 direction from a position shown by an imaginary line in FIG. 2, i.e., position corresponding to the point P0 of the graph in FIG. 4, the gap G is increased in a positive direction of a sine curve S0 in FIG. 4 and, if the eccentric bush 110 is rotated in the R2 direction, it follows that the gap G is decreased in a negative direction of the sine curve S0 in FIG. 4. Incidentally, in FIG. 4, a sine curve S1 shows a case of the eccentricity of a maximum tolerance, and a sine curve S2 shows a case of the eccentricity of a minimum tolerance.

For example, in case where the gap G becomes “0” or when the related members are constituted by such size, shape and disposition as to be a line denoted by G0 in FIG. 4, the G0 is made so as to become plus/minus less than 0.5 minutes and, typically, it follows that the eccentric bush 110 is turned such that it becomes a position denoted by a solid line or its vicinity. However, in that case, it is necessary that a size of the gap G is less than plus/minus 0.5 minutes at a position of α=+α0 with the size of the gap G having no relation to a dimension of the tolerance, i.e., even in case of a line S2.

Accordingly, for a safety in designing, for example, in case where the gap G becomes “0” when the related members are constituted by such size, shape and disposition as to be a line denoted by G1 in FIG. 4, it follows that the eccentric bush 110 is rotated such that the eccentric bush 110 adopts, between the position P0 and the solid line position, a proper position (position where the gap G becomes sufficiently small (for example, smaller than about 30 μm)) where the tip face 93a of the minute-counting hand reset arm portion 93 of the hammer 90 is not pressed to the minute heart 33.

Even if a play remains for the minute heart 33 in the R21 and R22 directions about the center axis C2 because of a slight gap remaining between the minute heart, reset face 93a and the corresponding portions 33a, 33a of the minute heart 33, a turning position of the minute-counting wheel 20 can be precisely positioned in minutes by the setting portion 35a of the minute counter jumper 35 engaging with teeth of the minute-counting gear wheel 22, so that it suffices if the gap G is decreased to less than plus/minus 0.5 minutes by the eccentric bush 110.

Incidentally, in place of fixing the eccentric bush 110 by the securing screw 98, it may be adapted such that, as shown in FIG. 3B, the eccentric bush 110 is merely fitted to the small diameter columnar portion 99c of the support pin 99.

Further, in place of forming the eccentric bush 110 separately from the support pin 99, the eccentric bush 110 may be formed integrally with the support pin 99. In that case, as shown in FIG. 3C for instance, by making a tip portion of the support pin 99h into a columnar portion 99f possessing an eccentric circumferential face 122 similarly to the outer peripheral face 112 of the eccentric cylindrical portion 113 of the eccentric bush 110, the columnar portion 99f may be caused to function as an eccentric means. In that case, by forming a groove 125 in an end face 126 of the columnar portion 99f, the pin 99h itself is made rotatable about the center axis C with respect to the main plate 6 and the like.

Incidentally, in the above, it has been explained about the example in which a portion of the tip portion side, in the support pin 99, of the operating lever 50 for the start/stop is used intact also as a pin for giving the rotation center C of the eccentric bush 110 of the hammer 90, but these two pins may not be disposed coaxially and may be separate pieces.

Next, concerning the chronograph mechanism 7 of the chronograph timepiece 3 of the watch 1 constituted as mentioned above, it is explained about a chronograph motion with an adjustment operation of reset position and a reset motion being made a center.

In a usual hand movement motion of the watch 1, the chronograph mechanism 7 adopts such a reset state as shown in FIG. 1. Accordingly, an adjustment of the reset position of the chronograph mechanism 7 is performed under a state similar to this hand movement state except a point that a whole of the watch 1 is not assembled yet.

The adjustment of the reset position of the chronograph mechanism 7 is performed before an attachment of the securing screw 98 (FIG. 3A) and before an attachment of the second-counting hand 18. Further, by rotating the eccentric bush 110 about the center axis C by engaging a tip portion of the minus driver with the groove 115 of the flange-like portion 114 of the eccentric bush 110, the eccentric bush 110 is set to an initial position (position shown by the point P0 in FIG. 4) shown by the imaginary line in FIG. 2. Next, under an action of the hammer spring 96, the hammer 90 is turned about the eccentric bush 110, i.e., about the center axis Q of the outer peripheral face 112 of the eccentric bush 110, and the second-counting hand reset arm portion 94 is collided against the second heart 23. A direction of the second heart 23, i.e., rotation direction of the second-counting wheel 20 about the center axis C1, is adjusted such that the tip face 94a of the second-counting hand reset arm portion 94 collides against both of the two symmetrical most adjacent positions 23a, 23a of the second heart 23. Next, under this state, the minute-counting wheel 30 is aligned in position as far as possible with respect to the tip face 93a of the minute-counting hand reset arm portion 93 of the hammer 90.

On this occasion, if a movable range in which the minute heart 33 of the minute-counting wheel 30 is regulated by the tip face 93a of the minute-counting hand reset arm portion 93 is in a range of less than plus/minus 0.5 minutes, it follows that as to its position the hammer 90 is properly positioned for the present also with respect to the minute heart 33. Additionally, if desired, the size of the gap G between the tip face 93a and the minute heart 33 may be judged by a visual observation and the like.

On the other hand, in case where a movable range of the minute heart 33 regulated by the tip face 93a of the minute-counting hand reset arm portion 93 exceeds plus/minus 0.5 minutes, since a clearance or the gap G between the tip face 93a of the minute-counting hand reset arm portion 93 and the most adjacent portions 33a, 33a of the minute heart 33 is too large (this size may be judged by the visual observation), this gap is made small by turning the eccentric bush 110 in the R1 direction with respect to the support pin 99. Incidentally, since it follows that the rotation of the eccentric bush 110 somewhat changes a direction and a position of the tip face 94a of the second-counting hand reset arm portion 94 of the hammer 90, the positions of the hammer 90 and the second heart 23 are adjusted such that the tip face 94a of the second-counting hand reset arm portion 94 collides against both of the two symmetrical most adjacent positions 23a, 23a of the second heart 23 at every time the eccentric bush 110 is rotated by a desired angle. In any case, by this gap reducing or decreasing operation, if the movable range of the minute heart 33 regulated by the tip face 93a of the minute-counting hand reset arm portion 93 becomes less than plus/minus 0.5 minutes, it follows that the gap G is suppressed within a proper range. Incidentally, under this state, if still the movable range of the minute heart 33 is comparatively wide and a suitable reduction of the gap is additionally possible, the movable range of the minute heart 33 maybe made smaller by additionally turning the eccentric bush 110 in the R1 direction.

In this manner, the second-counting wheel 20 including the second heart 23 (but, in this stage, the second-counting hand is not included) and the hammer 90 are positioned in predetermined positions, and the minute-counting wheel 30 including the minute heart 33 is positioned in a position within a predetermined range. Incidentally, since the minute-counting jumper 35 engages with the minute-counting gear wheel 32, if the minute heart 33, i.e., the minute-counting wheel 30, is positioned with an accuracy of plus/minus 0.5 minutes for instance, a deviation less than it can be forcibly set by the minute-counting jumper 35.

If such a positioning is completed, the securing screw 98 is driven, and the eccentric bush 110 is fixed to the support pin 98. Additionally, finally, the second-counting, hand 18 is attached to the second-counting arbor 21 so as to take a proper zero position on the dial 10, and a positioning or adjustment in the reset position, i.e., a control of the gap G, is completed.

On the occasion of this position adjustment, since it suffices if practically the eccentric bush 110 is merely rotated about the axis C practically within a range of less than plus/minus 90 degrees, its position adjustment can be performed easily and surely. Further, for the rotation of the eccentric bush 110, since it suffices if it is turned by causing one engaging with the eccentric bush 110 (in this example, the minus driver engaging with the groove 114, or the like) to engage with the bush 110, the adjustment or control of the gap G can be easily performed in comparison with a conventional driving of the non-columnar pin or a forced rotation.

Further, in this case, since it suffices if the eccentric bush 110 is merely interposed in the rotation center of the hammer 90, it is unnecessary to provide in the hammer a hole for driving the pin and an expanding slot to be split in different extent in compliance with a direction of the pin, and so on like a case of driving the non-columnar pin, so that not only an excessively large space is unnecessary but also a structure of the hammer can be simplified, and also an accuracy of its dimension/shape can be enhanced.

A chronograph motion itself of the chronograph mechanism 7 is similar to a conventional chronograph mechanism.

That is, under a usual hand movement state shown in FIG. 1, if the start/stop button 4 in FIG. 5 is pressed in the A1 direction, the operating lever 50 is pressed in the A1 direction, and the column wheel (pillar wheel) 40 is rotated by for one pitch of the ratchet teeth 41 by the pawl 51. On this occasion, the setting portion 87a of the hammer click. 85 is separated from the concave portion between the adjacent drive teeth (pillars) 42, 42 and pushed up to the outer peripheral face of the drive teeth 42 to rotate in the R82 direction, and the hammer regulating protrusion portion 87b engages with the shoulder portion 97a of the hammer 90 to rotate the hammer 90 in an RQ2 direction and completely release interferences with respect to the minute and second hearts 33, 23 of the arm portions 94, 93 of the hammer 90, and engages with the engaging portion 97 of the hammer 90. Further, with the rotation of the column wheel 40, the setting portion 62 of the stop lever 60 is pushed up to the outer peripheral face of the drive teeth 42 from the concave portion between the adjacent drive teeth 42, 42 to rotate the stop lever 60 in the R42 direction, and by this the chronograph coupling lever 70 is rotated in an R61 direction through the chronograph coupling lever spring 80, and the second counter intermediate wheel 24 meshes with the second-counting gear wheel 22. As a result, a rotation of the second-counting wheel 20 is started through the second counter intermediate wheel 24, and a chronograph motion is started (FIG. 6).

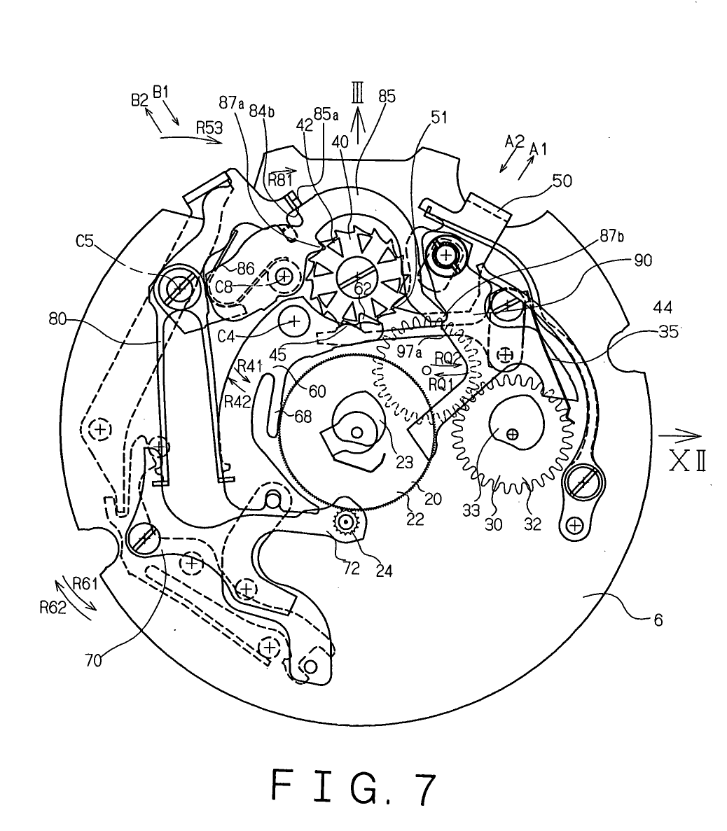

On the other hand, if the start/stop button 4 (FIG. 5) is pressed again in the A1 direction, the column wheel 40 is rotated again by for one pitch of the ratchet teeth 41 through the operating lever 50. As a result, the setting portion 62 of the stop lever 60 fits again into the concave portion between the adjacent drive teeth 42, 42 and is rotated in the R41 direction, and by this the chronograph coupling lever 70 is rotated in an R62 direction through the chronograph coupling lever spring 80, so that the meshing of the second counter intermediate wheel 24 with respect to the second-counting gearwheel 22 is released. Further, by the R41 direction rotation of the stop lever 60, the spring portion 68 of the stop lever 60 butts against the circumferential face of the second-counting gear wheel 22, thereby maintaining the second-counting wheel 20 to a stop position. By this, the chronograph mechanism 7 adopts a stop state (FIG. 7).

In order to return the chronograph mechanism 7 to the usual hand movement state by resetting it, the reset button 5 (FIG. 5) is pressed in the B1 direction, thereby pressing down the hammer operating lever 84 in FIG. 7. By this, the hammer click 85 is rotated in an R81 direction through the engaging structures 84b, 85a, the hammer regulating protrusion portion 87b of the hammer click 85 presses the hammer 90 in an RQ1 direction to separate from the shoulder portion 97a of the hammer 90, and the hammer regulating protrusion portion 87b of the hammer click 85 fits into the concave portion between the adjacent drive teeth 42, 42 of the column wheel 40. If the hammer click 85 separates from the hammer 90, the hammer 90 is rotated in the RQ2 direction under an action of the hammer spring 96 and, by the fact that tip end face 94a of the second-counting hand reset arm portion 94 collides against the second heart 23 to thereby position the second heart 23 to an initial position, the second-counting wheel 20 is returned to an initial position, thereby resetting the second-counting hand 18. With the rotation, in the RQ2 direction, of the hammer 90 position-adjusted by the eccentric bush 110, at the same time the tip face 93a of the minute-counting hand reset arm portion 93 collides against the minute heart 33 to thereby return the minute heart 33 to a vicinity of the initial position and, under an action of the minute-counting jumper 35, the minute-counting wheel 30 is accurately returned to the initial position, so that the minute-counting hand 17 is reset.

Incidentally, in the above, it has not been explained about the hour-counting hand, but the hour-counting hand is chronograph-operated by a mechanism similar to such a conventional mechanism as described in JP-A-11-183653 Gazette.

What is claimed is:

1. A mechanical chronograph timepiece comprising:
a hammer support member setting a basic center axis;
an eccentric member which is mounted to the hammer support member, which sets an adjustment center axis that is eccentric with respect to the basic center axis of the hammer support member; and in which a direction of an eccentricity of the adjustment center axis with respect to the basic center axis is adjustable;
a hammer possessing a base portion side arm portion supported by the eccentric member so as to be capable of turning about the adjustment center axis at a base end portion and two kinds of chronograph hand reset arm portions bifurcated/extended from a tip portion of the base portion side arm portion; and
hearts which are respectively capable of returning to their initial positions when pressed by tip portions of the chronograph hand reset arm portions and which are respectively attached to corresponding kinds of chronograph hands.

2. A mechanical chronograph timepiece according to claim 1, wherein the eccentric member is fitted to the hammer support member so as to be capable of turning about the basic center axis, and the base portion side arm portion of the hammer is fitted to the eccentric member so as to be capable of turning about the adjustment center axis.

3. A mechanical chronograph timepiece according to claim 1, wherein an engaged portion extending substantially in a diameter direction with respect to a reference center axis is formed in a surface of -the eccentric member such that a direction of an eccentricity by the eccentric member can be adjusted.

4. A mechanical chronograph timepiece according to claim 1, wherein the hammer support member has a columnar center axle which is supported by a main plate and whose center is the basic center axis, and the eccentric member has an eccentric bush which is fitted to the center axle by a cylindrical inner peripheral face and which possesses an outer peripheral face that is eccentric with respect to the inner peripheral face.

5. A mechanical chronograph timepiece according to claim 4, wherein the eccentric bush has a flange-like portion, and an engaged groove extending substantially in the diameter direction with respect to the reference center axis is formed in a surface of the flange-like portion.

6. A mechanical chronograph timepiece according to claim 5, further comprising a securing member for fixing the eccentric bush to the center axle.

7. A mechanical chronograph timepiece according to claim 1, wherein the hammer support member includes a main plate possessing a cylindrical hole whose center is the basic center axis, and the eccentric member has a base portion side columnar portion fitted to the cylindrical hole of the main plate, and a lever side columnar portion which is formed in one end side of the base portion side columnar portion and which is eccentric with respect to the base portion side columnar portion.

8. A mechanical chronograph timepiece according to claim 1, wherein the chronograph hands include a second-counting hand and a non-second-counting hand, and when a tip portion of, in the hammer, one chronograph hand reset arm portion corresponding to a second heart butts against the second heart and thus is in a state that it returns the second heart to its initial position, a relative position between a tip portion of, in the hammer, the other chronograph hand reset arm portion corresponding to a non-second heart and the non-second heart in its returned position is adjusted in compliance with the direction of the eccentricity of the eccentric means.

9. A watch possessing a mechanical chronograph timepiece according to claim 1.
